(19) United States
(12) Patent Application Publication
(10) Pub. No.: US 2023/0192536 A1
(43) Pub. Date: Jun. 22, 2023

(54) TEXTURED GLASS ARTICLES AND METHODS OF MAKING SAME

(71) Applicant: CORNING INCORPORATED, Corning, NY (US)

(72) Inventors: Xinyu Cao, Shanghai (CN); Ling Chen, Shanghai (CN); Wanghui Chen, Zhejiang (CN); Jiangwei Feng, Ithaca, NY (US); Meng Shang, Painted Post, NY (US)

(21) Appl. No.: 18/083,751

(22) Filed: Dec. 19, 2022

Related U.S. Application Data
(60) Provisional application No. 63/328,470, filed on Apr. 7, 2022.
(60) Provisional application No. 63/292,168, filed on Dec. 21, 2021.

(51) Int. Cl. C03C 15/00

(52) U.S. Cl. CPC C03C 15/00; C03C 2204/08

(57) ABSTRACT

A method of forming a textured glass article comprises: submerging an aluminosilicate glass article in an etchant to an upper submerging depth from a surface of the etchant and at a tilting angle, wherein the aluminosilicate glass article comprises a first major surface and a second major surface opposite the first surface, wherein the tilting angle is a smallest angle between a normal to the first major surface and a vertical; holding the aluminosilicate glass article in the etchant for a holding time; and after the holding time, cycling the aluminosilicate glass article in the etchant between the upper submerging depth and a lower submerging depth deeper than the upper submerging depth for a cycling time.

This application claims the benefit of priority of U.S. Provisional Application Ser. No. 63/328,470 filed on Apr. 7, 2022, and U.S. Provisional Application Ser. No. 63/292,168 filed on Dec. 21, 2021, the content of each are relied upon and incorporated herein by reference in their entirety.

### FIELD

The present specification generally relates to glass articles and, in particular, to glass articles having sufficient coverage and micro-uniformity of the surface features thereon.

### TECHNICAL BACKGROUND

Aluminosilicate glass articles may exhibit superior ion-exchangeability and drop performance. Various industries, including the consumer electronics industry, desire reflective materials with the same or similar strength and fracture toughness properties. However, conventional texturing processes may not produce the coverage and micro-uniformity of the surface features on certain aluminosilicate glass articles necessary to achieve the desired appearance.

Accordingly, a need exists for an alternative method to produce aluminosilicate glass articles having sufficient coverage and micro-uniformity of the surface features thereon.

### SUMMARY

According to a first aspect A1, a method of forming a textured glass article may comprise: submerging an aluminosilicate glass article in an etchant to an upper submerging depth from a surface of the etchant and at a tilting angle, wherein the aluminosilicate glass article comprises a first major surface and a second major surface opposite the first surface, wherein the tilting angle is a smallest angle between a normal to the first major surface and a vertical; holding the aluminosilicate glass article in the etchant for a holding time; and after the holding time, cycling the aluminosilicate glass article in the etchant between the upper submerging depth and a lower submerging depth deeper than the upper submerging depth for a cycling time.

A second aspect A2 includes the method according to the first aspect A1, wherein the tilting angle is greater than or equal to 0° and less than or equal to 20°.

A third aspect A3 includes the method according to the first aspect A1 or second aspect A2, wherein the holding time is greater than 0 s and less than or equal to 600 s.

A fourth aspect A4 includes the method according to the third aspect A3, wherein the holding time is greater than or equal to 30 s and less than or equal to 300 s.

A fifth aspect A5 includes the method according to any one of the first through fourth aspects A1-A4, wherein a temperature of the etchant is greater than or equal to 10° C. and less than or equal to 30° C.

A sixth aspect A6 includes the method according to the fifth aspect A5, wherein the temperature of the etchant is greater than or equal to 12° C. and less than or equal to 24° C.

A seventh aspect includes the method according to any one of the first through sixth aspects A1-A6, wherein the cycling is conducted at greater than or equal to 1 and less than or equal to 180 cycles per minute and at a speed of greater than or equal to 2 cm/s and less than or equal to 28 cm/s.

An eighth aspect A8 includes the method according to the seventh aspect A7, wherein the cycling is conducted at greater than or equal to 2 and less than or equal to 120 cycles per minute and at a speed of greater than or equal to 4 cm/s and less than or equal to 24 cm/s.

A ninth aspect A9 includes the method according to any one of the first through eighth aspects A1-A8, wherein the lower submerging depth is greater than or equal to 1 cm and less than or equal to 20 cm deeper than the upper submerging depth.

A tenth aspect A10 includes the method according to the ninth aspect A9, wherein the lower submerging depth is greater than or equal to 3 cm and less than or equal to 10 cm deeper than the upper submerging depth.

An eleventh aspect A11 includes the method according to any one of the first through tenth aspects A1-A10, further comprising, prior to submersing the aluminosilicate glass article in the etchant, preparing the etchant and allowing the etchant to settle for a settling time greater than or equal to 10 s and less than or equal to 600 s.

A twelfth aspect A12 includes the method according to any one of the first through eleventh aspects A1-A11, wherein the cycling time is greater than or equal to 60 s and less than or equal to 900 s.

A thirteenth aspect A13 includes the method according to any one of the first through twelfth aspects A1-A12, wherein the etchant comprises: greater than or equal to 10 wt % and less than or equal to 50 wt % of a salt; and greater than or equal to 5 wt % and less than or equal to 50 wt % of an acid.

A fourteenth aspect A14 includes the method according to the thirteenth aspect A13, wherein the salt comprises ammonium fluoride, ammonium bifluoride, ammonium sulfate, ammonium fluorosilicate, ammonium chloride, or combinations thereof.

A fifteenth aspect A15 includes the method according to the thirteenth aspect A13 or fourteenth aspect A14, wherein the acid comprises hydrochloric acid, sulfuric acid, hexafluorosilicic acid, or combinations thereof.

A sixteenth aspect A16 includes the method according to any one of the first through fifteenth aspects A15, wherein the etchant comprises greater than 0 wt % and less than or equal to 2 wt % xanthan gum.

A seventeenth aspect A17 includes the method according to any one of the first through thirteenth aspects A1-A13, wherein the etchant comprises: greater than or equal to 2 wt % and less than or equal to 20 wt % ammonium fluoride; greater than or equal to 2 wt % and less than or equal to 15 wt % ammonium bifluoride; greater than or equal to 2 wt % and less than or equal to 15 wt % ammonium sulfate; greater than or equal to 0.5 wt % and less than or equal to 10 wt % ammonium fluorosilicate; greater than or equal to 0.5 wt % and less than or equal to 10 wt % ammonium chloride; greater than or equal to 2 wt % and less than or equal to 20 wt % hydrochloric acid; greater than or equal to 0.25 wt % and less than or equal to 5 wt % hexafluorosilicic acid; and greater than or equal to 50 wt % and less than or equal to 70 wt % water.

An eighteenth aspect Alb includes the method according to any one of the first through thirteenth aspects A1-A13, wherein the etchant comprises: greater than or equal to 2 wt % and less than or equal to 20 wt % ammonium fluoride; greater than or equal to 0.5 wt % and less than or equal to 10 wt % ammonium bifluoride; greater than or equal to 2 wt % and less than or equal to 25 wt % ammonium sulfate; greater than or equal to 0.5 wt % and less than or equal to 10 wt % ammonium fluorosilicate; greater than or equal to 5 wt % and less than or equal to 25 wt % hydrochloric acid; and greater than or equal to 50 wt % and less than or equal to 70 wt % water.

A nineteenth aspect A19 includes the method according to any one of the first through thirteenth aspects A1-A13, wherein the etchant comprises: greater than or equal to 5 wt % and less than or equal to 30 wt % ammonium fluoride; greater than or equal to 0.5 wt % and less than or equal to 10 wt % ammonium fluorosilicate; greater than or equal to 20 wt % and less than or equal to 40 wt % sulfuric acid; and greater than or equal to 40 wt % and less than or equal to 60 wt % water.

A twentieth aspect A20 includes the method according to any one of the first through thirteenth aspects A1-A13, wherein the etchant comprises: greater than or equal to 5 wt % and less than or equal to 30 wt % ammonium bifluoride; greater than or equal to 2 wt % and less than or equal to 20 wt % ammonium sulfate; greater than or equal to 15 wt % and less than or equal to 35 wt % sulfuric acid; and greater than or equal to 40 wt % and less than or equal to 60 wt % water.

A twenty-first aspect A21 includes the method according to any one of the first through thirteenth aspects A1-A13, wherein the etchant comprises: greater than or equal to 10 wt % and less than or equal to 30 wt % ammonium fluoride; greater than or equal to 0.5 wt % and less than or equal to 10 wt % ammonium bifluoride; greater than or equal to 0.5 wt % and less than or equal to 10 wt % ammonium fluorosilicate; greater than or equal to 20 wt % and less than or equal to 40 wt % sulfuric acid; and greater than or equal to 40 wt % and less than or equal to 60 wt % water.

A twenty-second aspect A22 includes the method according to any one of the first through thirteenth aspects A1-A13, wherein the etchant comprises: greater than or equal to 10 wt % and less than or equal to 30 wt % ammonium fluoride; greater than or equal to 2 wt % and less than or equal to 15 wt % ammonium bifluoride; greater than or equal to 2 wt % and less than or equal to 20 wt % ammonium sulfate; greater than or equal to 0.5 wt % and less than or equal to 10 wt % ammonium fluorosilicate; greater than or equal to 0.5 wt % and less than or equal to 10 wt % ammonium chloride; greater than or equal to 2 wt % and less than or equal to 20 wt % hydrochloric acid; greater than or equal to 0.25 wt % and less than or equal to 5 wt % hexafluorosilicic acid; greater than or equal to 40 wt % and less than or equal to 60 wt % water; and greater than 0 wt % and less than or equal to 2 wt % xanthan gum.

A twenty-third aspect A23 includes the method according to any one of the first through twenty-second aspects A1-A22, herein the aluminosilicate glass article comprises greater than or equal to 14 mol % Al₂O₃.

A twenty-fourth aspect A24 includes the method according to any one of the first through twenty-third aspects A1-A23, wherein the aluminosilicate glass article comprises: greater than or equal to 56 mol % and less than or equal to 72 mol % SiO₂; greater than or equal to 14 mol % and less than or equal to 25 mol % Al₂O₃; greater than or equal to 6 mol % and less than or equal to 16 mol % Na₂O; greater than or equal to 1 mol % and less than or equal to 10 mol % Li₂O; greater than or equal to 0 mol % and less than or equal to 3 mol % ZnO; and greater than or equal to 0 mol % and less than or equal to 3 mol % P₂O₅.

A twenty-fifth aspect A25 includes the method according to any one of the first through twenty-third aspects A1-A23, wherein the aluminosilicate glass article comprises: greater than or equal to 50 mol % and less than or equal to 66 mol % SiO₂; greater than or equal to 16 mol % and less than or equal to 28 mol % Al₂O₃; greater than or equal to 1 mol % and less than or equal to 8 mol % B₂O₃; greater than or equal to 3 mol % and less than or equal to 15 mol % Na₂O; greater than or equal to 0 mol % and less than or equal to 1 mol % K₂O; greater than or equal to 1 mol % and less than or equal to 12 mol % Li₂O; greater than or equal to 0 mol % and less than or equal to 3 mol % MgO; greater than or equal to 0 mol % and less than or equal to 3 mol % P₂O₅; and greater than or equal to 0 mol % and less than or equal to 1 mol % TiO₂.

A twenty-sixth aspect A25 includes the method of any one of the first through twenty-fifth aspects A1-A25, wherein the textured glass article comprises a plurality of polyhedral surface features extending from a first surface, each of the plurality of polyhedral surface features comprising a base on the first surface, a plurality of facets extending from the first surface, and a surface feature size at the base greater than or equal to 50 μm and less than or equal to 500 μm, wherein the plurality of facets of each polyhedral surface feature converge toward one another.

A twenty-seventh aspect A27 includes the method of the twenty-sixth aspect A26, wherein the textured glass article has sufficient coverage and micro-uniformity of the plurality of polyhedral surface features.

According to a twenty-eighth aspect A28 an etchant may comprise: greater than or equal to 10 wt % and less than or equal to 50 wt % of a salt, the salt comprising ammonium fluoride, ammonium bifluoride, ammonium sulfate, ammonium fluorosilicate, ammonium chloride, or combinations thereof; and greater than or equal to 5 wt % and less than or equal to 50 wt % of an acid, the acid comprising hydrochloric acid, sulfuric acid, hexafluorosilicic acid, or combinations thereof.

A twenty-ninth aspect A29 includes the etchant according to the twenty-eighth aspect A28, wherein the etchant comprises greater than 0 wt % and less than or equal to 2 wt % xanthan gum.

A thirtieth aspect A30 includes the etchant according to the twenty-eighth aspect A28, wherein the etchant comprises: greater than or equal to 2 wt % and less than or equal to 20 wt % ammonium fluoride; greater than or equal to 2 wt % and less than or equal to 15 wt % ammonium bifluoride; greater than or equal to 2 wt % and less than or equal to 15 wt % ammonium sulfate; greater than or equal to 0.5 wt % and less than or equal to 10 wt % ammonium fluorosilicate; greater than or equal to 0.5 wt % and less than or equal to 10 wt % ammonium chloride; greater than or equal to 2 wt % and less than or equal to 20 wt % hydrochloric acid; greater than or equal to 0.25 wt % and less than or equal to 5 wt % hexafluorosilicic acid; and greater than or equal to 50 wt % and less than or equal to 70 wt % water.

A thirty-first aspect A31 includes the etchant according to the twenty-eighth aspect A28, wherein the etchant comprises: greater than or equal to 2 wt % and less than or equal to 20 wt % ammonium fluoride; greater than or equal to 0.5 wt % and less than or equal to 10 wt % ammonium bifluoride; greater than or equal to 2 wt % and less than or equal to 25 wt % ammonium sulfate; greater than or equal to 0.5 wt % and less than or equal to 10 wt % ammonium fluorosilicate; greater than or equal to 5 wt % and less than or equal to 25 wt % hydrochloric acid; and greater than or equal to 50 wt % and less than or equal to 70 wt % water.

A thirty-second aspect A32 includes the etchant according to the twenty-eighth aspect A28, wherein the etchant comprises: greater than or equal to 5 wt % and less than or equal to 30 wt % ammonium fluoride; greater than or equal to 0.5 wt % and less than or equal to 10 wt % ammonium fluorosilicate; greater than or equal to 20 wt % and less than or equal to 40 wt % sulfuric acid; and greater than or equal to 40 wt % and less than or equal to 60 wt % water.

A thirty-third aspect A33 includes the etchant according to the twenty-eighth aspect A28, wherein the etchant comprises: greater than or equal to 5 wt % and less than or equal to 30 wt % ammonium bifluoride; greater than or equal to 2 wt % and less than or equal to 20 wt % ammonium sulfate; greater than or equal to 15 wt % and less than or equal to 35 wt % sulfuric acid; and greater than or equal to 40 wt % and less than or equal to 60 wt % water.

A thirty-fourth aspect A34 includes the etchant according to the twenty-eighth aspect A28, wherein the etchant comprises: greater than or equal to 10 wt % and less than or equal to 30 wt % ammonium fluoride; greater than or equal to 0.5 wt % and less than or equal to 10 wt % ammonium bifluoride; greater than or equal to 0.5 wt % and less than or equal to 10 wt % ammonium fluorosilicate; greater than or equal to 20 wt % and less than or equal to 40 wt % sulfuric acid; and greater than or equal to 40 wt % and less than or equal to 60 wt % water.

A thirty-fifth aspect A35 includes the etchant according to the twenty-eighth aspect A28, wherein the etchant comprises: greater than or equal to 10 wt % and less than or equal to 30 wt % ammonium fluoride; greater than or equal to 2 wt % and less than or equal to 15 wt % ammonium bifluoride; greater than or equal to 2 wt % and less than or equal to 20 wt % ammonium sulfate; greater than or equal to 0.5 wt % and less than or equal to 10 wt % ammonium fluorosilicate; greater than or equal to 0.5 wt % and less than or equal to 10 wt % ammonium chloride; greater than or equal to 2 wt % and less than or equal to 20 wt % hydrochloric acid; greater than or equal to 0.25 wt % and less than or equal to 5 wt % hexafluorosilicic acid; greater than or equal to 40 wt % and less than or equal to 60 wt % water; and greater than 0 wt % and less than or equal to 2 wt % xanthan gum.

Additional features and advantages of the textured glass articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a flow diagram of a method of forming a textured glass article, according to one or more embodiments shown and described herein;

FIG. 2 schematically depicts a plan view of an aluminosilicate glass article, according to one or more embodiments shown and described herein;

FIG. 3 schematically depicts an etchant reacting with an aluminosilicate article, according to one or more embodiments shown or described herein;

FIG. 4 schematically depicts a step of an agitation process, according to one or more embodiments shown and described herein;

FIG. 5 schematically depicts another step of the agitation process, according to one or more embodiments shown and described herein;

FIG. 6 schematically depicts a plan view of a textured glass article, according to one or more embodiments shown and described herein;

FIG. 7 schematically depicts a plan view of a polyhedral surface feature, according to one or more embodiments shown and described herein;

FIG. 8 schematically depicts a plan view of another polyhedral surface feature, according to one or more embodiments shown and described herein;

FIG. 9 schematically depicts a plan view of another polyhedral surface feature, according to one or more embodiments shown and described herein;

FIG. 10 schematically depicts a plan view of another polyhedral surface feature, according to one or more embodiments shown and described herein;

FIG. 11 is a plan view of an exemplary electronic device incorporating any of the textured glass articles, according to one or more embodiments shown and described herein;

FIG. 12 is a perspective view of the exemplary electronic device of FIG. 11;

FIG. 13 is a perspective view of the exemplary electronic device of FIG. 11;

FIG. 14 is an optical microscope image with a magnification of 50× of a textured glass article, according to one or more embodiments shown and described herein;

FIG. 15 is an optical microscope image with a magnification of 200× of the textured glass article shown in FIG. 14;

FIG. 16 is an optical microscope image with a magnification of 50× of a textured glass article, according to one or more embodiments shown and described herein;

FIG. 17 is an optical microscope image with a magnification of 200× of the textured glass article shown in FIG. 16;

FIG. 18 is an optical microscope image with a magnification of 50× of a textured glass article, according to one or more embodiments shown and described herein;

FIG. 19 is an optical microscope image with a magnification of 200× of the textured glass article shown in FIG. 18;

FIG. 20 is an optical microscope image with a magnification of 50× of a comparative textured glass article;

FIG. 21 is an optical microscope image with a magnification of 50× of a comparative textured glass article;

FIG. 22 is an optical microscope image with a magnification of 50× of a textured glass article, according to one or more embodiments shown and described herein;

FIG. 23 is an optical microscope image with a magnification of 200× of the textured glass article shown in FIG. 22;

FIG. 24 is an optical microscope image with a magnification of 50× of a comparative textured glass article;

FIG. 25 is an optical microscope image with a magnification of 200× of the comparative textured glass article shown in FIG. 24;

FIG. 26 is an optical microscope image with a magnification of 50× of a textured glass article, according to one or more embodiments shown and described herein;

FIG. 27 is an optical microscope image with a magnification of 50× of a textured glass article, according to one or more embodiments shown and described herein;

FIG. 28 is an optical microscope image with a magnification of 200× of the textured glass article shown in FIG. 27;

FIG. 29 is an optical microscope image with a magnification of 50× of a comparative textured glass article;

FIG. 30 is an optical microscope image with a magnification of 50× of a comparative textured glass article; and

FIG. 31 is an optical microscope image with a magnification of 50× of a comparative textured glass article.

### DETAILED DESCRIPTION

Reference will now be made in detail to various embodiments of textured glass articles having sufficient coverage and micro-uniformity of the polyhedral surface features thereon. According to embodiments, method of forming a textured glass article comprises: submerging an aluminosilicate glass article in an etchant to an upper submerging depth from a surface of the etchant and at a tilting angle, wherein the aluminosilicate glass article comprises a first major surface and a second major surface opposite the first surface, wherein the tilting angle is a smallest angle between a normal to the first major surface and a vertical; holding the aluminosilicate glass article in the etchant for a holding time; and after the holding time, cycling the aluminosilicate glass article in the etchant between the upper submerging depth and a lower submerging depth deeper than the upper submerging depth for a cycling time. Various embodiments of textured glass articles and methods of making the same will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

In the embodiments of the glass compositions described herein, the concentrations of constituent components (e.g., SiO₂, Al₂O₃, and the like) are specified in mole percent (mol %) on an oxide basis, unless otherwise specified.

Optical microscope images, as described herein, are obtained using Nikon Eclipse L200N optical microscope with 5× or 20× objectives and multiple 10× from eyepiece for a total magnification of 50× or 200×.

“Surface feature size,” as described herein, is measured using optical microscopy at 200× magnification. Images are obtained of two different 500 μm×1000 μm scanned areas. In each image, the maximum distance across the cross section of the base of the 10 largest surface features is measured. “Surface feature size” refers to the average maximum distance across the cross section of the base of the 20 surface features from the two scanned areas. For example, for surface features with a triangular base, the maximum distance across the cross section of the base is the height of the triangular base. For surface features with a rectangular base, the maximum distance across the cross section of the base is the diagonal measurement across the base. For surface features with a hexagonal base, the maximum distance across the cross section of the base in the largest measurement between opposed vertices.

“Individual feature size,” as described herein, is measured using optical microscopy and refers to the maximum distance across the cross section of the base of a single polyhedral surface feature.

“Sufficient coverage,” when used herein to describe the plurality of polyhedral surface features of the textured glass article, refers to the polyhedral surface features covering greater than or equal to 90% of a major surface of the textured glass article.

“Micro-uniformity,” when used herein to describe the plurality of polyhedral surface features of the textured glass article, refers to the individual feature sizes not varying more than 20%.

“Dominate texture phase,” as used herein, refers to the identified polyhedral surface feature(s) (e.g., triangular pyramids, quadrangular pyramids, hexagonal pyramids, octagonal pyramids) being present in an amount (or total amount if two or more surface features are identified) greater than or equal to 70% based on a total amount of polyhedral surface features of the textured glass article. “Minor texture phase,” as used herein, refers to the identified polyhedral surface feature(s) being present in an amount (or total amount if two or more surface features are identified less than or equal to 30% based on a total amount of polyhedral surface features of the textured glass article. If the identified feature(s) is present in an amount greater than 30% and less than 70%, then the textured glass article is described as having two or more co-existing texture phases.

“Polyhedral,” when used to describe the structure of a surface feature on a textured glass article, refers to a three-dimensional shape with flat polygonal faces and straight edges.

“Dendritic,” when used to describe the structure of a surface feature on a textured glass article, refers to a branching structure.

“Agitation parameters,” as described herein, refer to settling time, tilting angle, upper submerging depth, lower submerging depth, cycling time, cycling speed, cycles per minute, and etchant temperature.

“Agitating” or “Agitation process,” as described herein, are defined by the steps of preparing the etchant and allowing the etchant to settle for a settling time, submerging the glass article in the etchant to an upper submerging depth from a surface of the etchant and at a tilting angle, holding the glass article in the etchant for a holding time, and cycling the aluminosilicate glass article in the etchant between the upper submerging depth and a lower submerging depth for a cycling time.

Etchants have been used to achieve textured surfaces on glass articles. Properties of the textured surfaces, including the structure, size, coverage, and micro-uniformity of the surface features may effect the appearance (e.g., reflectivity or “glowing effect”) of the textured glass article. Due to their flat polygonal faces and straight edges, polyhedral surface features may achieve a better “glowing effect” than dendritic surface features. While conventional texturing processes may result in polyhedral surface features, such processes may not result in the coverage and micro-uniformity of the polyhedral surface features necessary to achieve the desired appearance.

Disclosed herein are textured glass articles and texturing methods which mitigate the aforementioned problems such that aluminosilicate glasses may be treated to have sufficient coverage and micro-uniformity of polyhedral surface features thereon. Specifically, to achieve sufficient coverage and micro-uniformity of surface features, the methods of forming a textured glass article disclosed herein comprise agitating the textured glass article by submerging an aluminosilicate glass article in an etchant to an upper submerging depth from a surface of the etchant and at a tilting angle, holding the aluminosilicate glass article in the etchant for a holding time, and, after the holding time, cycling the aluminosilicate glass article in the etchant between the upper submerging depth and a lower submerging depth deeper than the upper submerging depth for a cycling time. To achieve the desired “glowing effect,” the etchant should preferentially generate a silicon-based precipitate, which leads to large, polyhedral surface features, and minimize the aluminum-based precipitate, which leads to small, dendritic surface features.

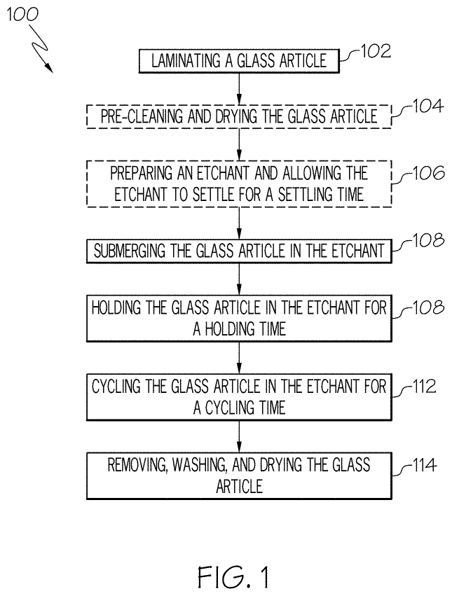

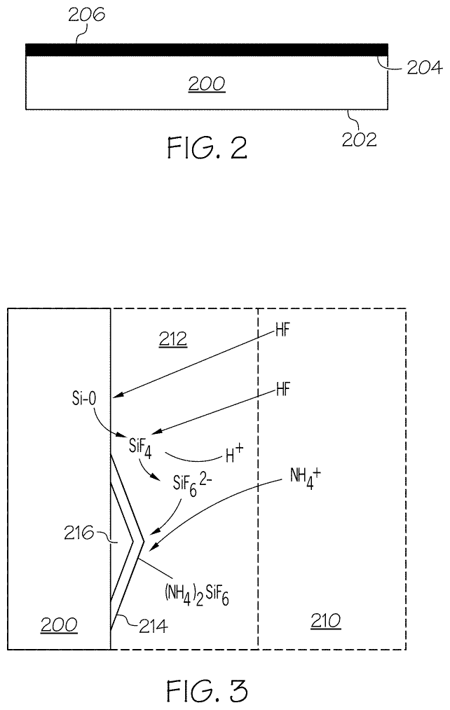

Referring now to FIGS. 1 and 2, the method 100 of forming a textured glass article begins at block 102 with laminating an aluminosilicate glass article 200 with a laminate 206. The aluminosilicate glass article 200 may be in the form of a plate having a first major surface 202 and a second major surface 204 opposite the first major surface 202. As shown in FIG. 2, the laminate 206 may contact the second major surface 204 of the aluminosilicate glass article 200. In embodiments, the laminate 206 may be a polyethylene film with an adhesive layer. In embodiments, laminating the aluminosilicate glass article 200 may be conducted in a roller lamination machine.

In embodiments, the aluminosilicate glass article 200 may comprise greater than or equal to 14 mol % Al₂O₃. In embodiments, the aluminosilicate glass article 200 may comprise greater than or equal to 50 mol % and less than or equal to 66 mol % SiO₂; greater than or equal to 16 mol % and less than or equal to 28 mol % Al₂O₃; greater than or equal to 1 mol % and less than or equal to 8 mol % B₂O₃; greater than or equal to 3 mol % and less than or equal to 15 mol % Na₂O; greater than or equal to 0 mol % and less than or equal to 1 mol % K₂O; greater than or equal to 1 mol % and less than or equal to 12 mol % Li₂O; greater than or equal to 0 mol % and less than or equal to 3 mol % MgO; greater than or equal to 0 mol % and less than or equal to 3 mol % P₂O₅; and greater than or equal to 0 mol % and less than or equal to 1 mol % TiO₂. In embodiments, the aluminosilicate glass article 200 may comprise greater than or equal to 50 mol % and less than or equal to 66 mol % SiO₂; greater than or equal to 16 mol % and less than or equal to 28 mol % Al₂O₃; greater than or equal to 1 mol % and less than or equal to 8 mol % B₂O₃; greater than or equal to 3 mol % and less than or equal to 15 mol % Na₂O; greater than or equal to 0 mol % and less than or equal to 1 mol % K₂O; greater than or equal to 1 mol % and less than or equal to 12 mol % Li₂O; greater than or equal to 0 mol % and less than or equal to 3 mol % MgO; greater than or equal to 0 mol % and less than or equal to 3 mol % P₂O₅; and greater than or equal to 0 mol % and less than or equal to 1 mol % TiO₂.

Referring back to FIG. 1, in embodiments, the method 100 may optionally continue at block 104 with pre-cleaning (e.g., in an aqueous solution followed by rinsing (e.g., with DI water)) and drying (e.g., in an oven) the aluminosilicate glass article 200.

Referring back to FIG. 1, in embodiments, the method 100 may optionally continue at block 106 with preparing an etchant 210 and allowing the etchant 210 to settle for a settling time prior to submersing the aluminosilicate glass article 200 in the etchant 210. The settling time may be altered to help achieve sufficient coverage and micro-uniformity of the polyhedral surface features of the textured glass article. In embodiments, the settling time may be greater than or equal to 10 s and less than or equal to 600 s. In embodiments, the settling time may be greater than or equal to 10 s, greater than or equal to 30 s, greater than or equal to 60 s, or even greater than or equal to 120 s. In embodiments, the settling time may be less than or equal to 600 s, less than or equal to 480 s, less than or equal to 360 s, or even less than or equal to 300 s. In embodiments, the settling time may be greater than or equal to 10 s and less than or equal to 600 s, greater than or equal to 10 s and less than or equal to 480 s, greater than or equal to 10 s and less than or equal to 360 s, greater than or equal to 10 s and less than or equal to 300 s, equal to 30 s and less than or equal to 600 s, greater than or equal to 30 s and less than or equal to 480 s, greater than or equal to 30 s and less than or equal to 360 s, greater than or equal to 30 s and less than or equal to 300 s, equal to 60 s and less than or equal to 600 s, greater than or equal to 60 s and less than or equal to 480 s, greater than or equal to 60 s and less than or equal to 360 s, greater than or equal to 60 s and less than or equal to 300 s, equal to 120 s and less than or equal to 600 s, greater than or equal to 120 s and less than or equal to 480 s, greater than or equal to 120 s and less than or equal to 360 s, or even greater than or equal to 120 s and less than or equal to 300 s, or any and all sub-ranges formed from any of these endpoints.

In embodiments, the etchant may be prepared by blending the components in powder form by hand mill and pre-mixing and stirring the components in liquid/solvent form to a homogenous state. The mixture of powder and liquid may be performed with pouring and stirring. In embodiments including xanthan gum as described herein, the pre-mixed solvent may be heated to 40° C. prior to mixing with the powder. The resulting etchant may be aged for greater than or equal to 2 hours.

To produce the desired “glowing effect,” the etchants described herein are prepared such that the etchant preferentially generates a silicon-based precipitate and minimizes the amount of aluminum based-precipitate. Silicon-based precipitates (e.g., metal fluorosilicate (MSiF₆)) lead to large, polyhedral surface features, which reflect more light than dendritic surface features. Aluminum-based precipitates (e.g., metal aluminofluoride (MAlF₅)) lead to small, dendritic surface features.

Referring now to FIG. 3, in embodiments, the etchant, 210 described herein may include hydrogen fluoride (HF) species and ammonium (NH₄) ions. The etchant 210 reacts with the aluminosilicate glass article 200, which causes HF species from the etchant 210 to diffuse into the aluminosilicate glass article 200 and corrode the Si—O network. SiF₄ is released from the aluminosilicate glass article 200 and reacts with HF to generate SiF₆² ions. The NH₄ ions from the etchant 210 diffuse to an interface 212 of the etchant 210 and aluminosilicate glass article 200 and react with the SiF₆² ions to produce ammonium fluorosilicate ((NH₄)₂SiF₆) precipitates. Because these precipitates have low solubility in the etchant 210, they then deposit on the surface of the aluminosilicate glass article 200 to form crystal seeds 214 (e.g., salt crusts).

As the etchant 210 continues to react with the aluminosilicate glass article 200, the crystal seeds 214 grow. Because the crystal seeds 214 are insoluble in the etchant, the crystal seeds 214 serve as an in-situ mask. The crystal seeds 214 seal portions of the surface of the aluminosilicate glass article 200. Glass is etched away around the crystal seeds 214 to generate polyhedral surface features 216. The shape of the polyhedral surface features 216 may be determined by the shape of the crystal seeds 214, which may be altered by varying the composition of the etchant 210 and/or varying the length of time the etchant contacts the aluminosilicate glass article 200.

In embodiments, hydrogen fluoride in the etchant 210 may form from the reaction of ammonium fluoride (NH₄F) or ammonium bifluoride (NH₄HF₂) with sulfuric acid (H₂SO₄) and hydrochloric acid (HCl). Ammonium fluoride and ammonium bifluoride may also be ammonium sources. In addition to ammonium fluoride and ammonium bifluoride, ammonium sources present in the etchant 210 may include ammonium sulfate ((NH₄)₂SO₄), ammonium fluorosilicate ((NH₄)₂SiF₆), and/or ammonium chloride (NH₄Cl). Ammonium fluorosilicate and hexafluorosilicic acid (H₂SiF₆) may be used to enhance the concentration of SiF₆ ions, thereby speeding up the precipitation of ammonium fluorosilicate on the aluminosilicate glass article 200.

H ions released from the etchant 210 may also act as regulators for the etching rate of the aluminosilicate glass article 200 and growth rate of the ammonium fluorosilicate precipitates. In addition to sulfuric acid and hydrochloric acid, the hexafluorosilicic acid may be used to release H ions from the etchant 210.

In embodiments, the etchant 210 may comprise a salt and an acid, as described in further detail below.

The salt present in the etchant 210 acts as a crystallization promoter, encouraging the formation of crystal seeds. In embodiments, the salt may comprise ammonium chloride, ammonium fluoride, ammonium bifluoride, ammonium sulfate, ammonium nitrate, ammonium fluorosilicate, potassium sulfate, potassium chloride, potassium fluoride, potassium bifluoride, potassium nitrate, sodium chloride, sodium fluoride, sodium bifluoride, or combinations. The amount of the salt in the etchant 210 should be sufficiently high (e.g., greater than or equal to 10 wt %) to ensure the formation of the crystal seeds. The amount of salt may be limited (e.g., less than or equal to 50 wt %) to reduce or prevent undissolved salt that may precipitate out once solubility is reached. Undissolved salt may etch differently than the etchant and may cause a lack of micro-uniformity. In embodiments, the etchant 210 may comprise greater than or equal to 10 wt % and less than or equal to 50 wt % of a salt. In embodiments, the amount of the salt in the etchant may be greater than or equal to 10 wt %, greater than or equal to 15 wt %, greater than or equal to 20 wt %, or even greater than or equal to 25 wt %. In embodiments, the amount of the salt in the etchant may be less than or equal to 50 wt %, less than or equal to 45 wt %, or even less than or equal to 40 wt %. In embodiments, the amount of the salt in the etchant may be greater than or equal to 10 wt % and less than or equal to 50 wt %, greater than or equal to 10 wt % and less than or equal to 45 wt %, greater than or equal to 10 wt % and less than or equal to 40 wt %, greater than or equal to 15 wt % and less than or equal to 50 wt %, greater than or equal to 15 wt % and less than or equal to 45 wt %, greater than or equal to 15 wt % and less than or equal to 40 wt %, greater than or equal to 20 wt % and less than or equal to 50 wt %, greater than or equal to 20 wt % and less than or equal to 45 wt %, greater than or equal to 20 wt % and less than or equal to 40 wt %, greater than or equal to 25 wt % and less than or equal to 50 wt %, greater than or equal to 25 wt % and less than or equal to 45 wt %, or even greater than or equal to 25 wt % and less than or equal to 40 wt %, or any and all sub-ranges formed from any of these endpoints.

The acid present in the etchant 210 functions to dissolve the components of the glass network of the aluminosilicate glass article 200 and form the polyhedral surface features 216. In embodiments, the acid may comprise hydrochloric acid, hydrofluoric acid, nitric acid, sulfuric acid, hexafluorosilicic acid, oxalic acid, acetic acid, bisulfate salt (e.g., sodium bisulfate) or combinations thereof. The amount of the acid in the etchant 210 should be sufficiently high (e.g., greater than or equal to 5 wt %) to ensure etching of glass and the formation of the textured glass article. The amount of acid may be limited (e.g., less than or equal to 50 wt %) to ensure polyhedral surface features are produced. When an excessive amount of acid is added, the polyhedral surface features may be corroded to a smaller size, losing their reflective appearance. In embodiments, the etchant 210 may comprise greater than or equal to 5 wt % and less than or equal to 50 wt % of an acid. In embodiments, the amount of the acid in the etchant 210 may be greater than or equal to 5 wt %, greater than or equal to 10 wt %, greater than or equal to 15 wt %, greater than or equal to 20 wt %, or even greater than or equal to 25 wt %. In embodiments, the amount of the acid in the etchant 210 may be less than or equal to 50 wt %, less than or equal to 45 wt %, less than or equal to 40 wt %, or even less than or equal to 35 wt %. In embodiments, the amount of the acid in the etchant may be greater than or equal to 5 wt % and less than or equal to 50 wt %, greater than or equal to 5 wt % and less than or equal to 45 wt %, greater than or equal to 5 wt % and less than or equal to 40 wt %, greater than or equal to 5 wt % and less than or equal to 35 wt %, greater than or equal to 10 wt % and less than or equal to 50 wt %, greater than or equal to 10 wt % and less than or equal to 45 wt %, greater than or equal to 10 wt % and less than or equal to 40 wt %, greater than or equal to 10 wt % and less than or equal to 35 wt %, greater than or equal to 15 wt % and less than or equal to 50 wt %, greater than or equal to 15 wt % and less than or equal to 45 wt %, greater than or equal to 15 wt % and less than or equal to 40 wt %, greater than or equal to 15 wt % and less than or equal to 35 wt %, greater than or equal to 20 wt % and less than or equal to 50 wt %, greater than or equal to 20 wt % and less than or equal to 45 wt %, greater than or equal to 20 wt % and less than or equal to 40 wt %, greater than or equal to 20 wt % and less than or equal to 35 wt %, greater than or equal to 25 wt % and less than or equal to 50 wt %, greater than or equal to 25 wt % and less than or equal to 45 wt %, greater than or equal to 25 wt % and less than or equal to 40 wt %, or even greater than or equal to 25 wt % and less than or equal to 35 wt %, or any and all sub-ranges formed from any of these endpoints.

In embodiments, the etchant 210 may further include a solvent. In embodiments, the solvent may comprise water, an acid (e.g., hydrochloric acid and/or hydrofluoric acid), or combinations thereof. In embodiments, the etchant 210 may comprise greater than or equal to 40 wt % and less than or equal to 60 wt % of the solvent. In embodiments, the etchant 210 may comprise greater than or equal to 50 wt % and less than or equal to 70 wt % of the solvent. In embodiments, the amount of solvent in the etchant 210 may be greater than or equal to 40 wt %, greater than or equal to 45 wt %, or even greater than or equal to 50 wt %. In embodiments, the amount of the solvent in the etchant 210 may be less than or equal to 70 wt %, less than or equal to 65 wt %, or even less than or equal to 60 wt %. In embodiments, the amount of the solvent in the etchant 210 may be greater than or equal to 40 wt % and less than or equal to 70 wt %, greater than or equal to 40 wt % and less than or equal to 65 wt %, greater than or equal to 40 wt % and less than or equal to 60 wt %, greater than or equal to 45 wt % and less than or equal to 70 wt %, greater than or equal to 45 wt % and less than or equal to 65 wt %, greater than or equal to 45 wt % and less than or equal to 60 wt %, greater than or equal to 50 wt % and less than or equal to 70 wt %, greater than or equal to 50 wt % and less than or equal to 65 wt %, or even greater than or equal to 50 wt % and less than or equal to 60 wt %, or any and all sub-ranges formed from any of these endpoints.

In embodiments, the etchant 210 may further include xanthan gum to increase the viscosity of the etchant 210 and, thereby, regulate flowability and diffusion rate of active species. In embodiments, the etchant 210 may comprise greater than 0 wt % and less than or equal to 2 wt % xanthan gum. In embodiments, the amount of xanthan gum in the etchant 210 may be greater than or equal to 0 wt %, greater than or equal to 0.1 wt %, or even greater than or equal to 0.25 wt %. In embodiments, the amount of xanthan gum in the etchant 210 may be less than or equal to 2 wt % or even less than or equal to 1 wt %. In embodiments, the amount of xanthan gum in the etchant may be greater than or equal to 0 wt % and less than or equal to 2 wt %, greater than or equal to 0 wt % and less than or equal to 1 wt %, greater than or equal to 0.1 wt % and less than or equal to 2 wt %, greater than or equal to 0.1 wt % and less than or equal to 1 wt %, greater than or equal to 0.25 wt % and less than or equal to 2 wt %, or even greater than or equal to 0.25 wt % and less than or equal to 1 wt %, or any and all sub-ranges formed from any of these endpoints.

In embodiments, the etchant 210 may comprise greater than or equal to 2 wt % and less than or equal to 20 wt % ammonium fluoride; greater than or equal to 2 wt % and less than or equal to 15 wt % ammonium bifluoride; greater than or equal to 2 wt % and less than or equal to 15 wt % ammonium sulfate; greater than or equal to 0.5 wt % and less than or equal to 10 wt % ammonium fluorosilicate; greater than or equal to 0.5 wt % and less than or equal to 10 wt % ammonium chloride; greater than or equal to 2 wt % and less than or equal to 20 wt % hydrochloric acid; greater than or equal to 0.25 wt % and less than or equal to 5 wt % hexafluorosilicic acid; and greater than or equal to 50 wt % and less than or equal to 70 wt % water.

In embodiments, the etchant 210 may comprise greater than or equal to 2 wt % and less than or equal to 20 wt % ammonium fluoride; greater than or equal to 0.5 wt % and less than or equal to 10 wt % ammonium bifluoride; greater than or equal to 2 wt % and less than or equal to 25 wt % ammonium sulfate; greater than or equal to 0.5 wt % and less than or equal to 10 wt % ammonium fluorosilicate; greater than or equal to 5 wt % and less than or equal to 25 wt % hydrochloric acid; and greater than or equal to 50 wt % and less than or equal to 70 wt % water.

In embodiments, the etchant 210 may comprise greater than or equal to 5 wt % and less than or equal to 30 wt % ammonium fluoride; greater than or equal to 0.5 wt % and less than or equal to 10 wt % ammonium fluorosilicate; greater than or equal to 20 wt % and less than or equal to 40 wt % sulfuric acid; and greater than or equal to 40 wt % and less than or equal to 60 wt % water.

In embodiments, the etchant may comprise greater than or equal to 5 wt % and less than or equal to 30 wt % ammonium bifluoride; greater than or equal to 2 wt % and less than or equal to 20 wt % ammonium sulfate; greater than or equal to 15 wt % and less than or equal to 35 wt % sulfuric acid; and greater than or equal to 40 wt % and less than or equal to 60 wt % water.

In embodiments, the etchant 210 may comprise greater than or equal to 10 wt % and less than or equal to 30 wt % ammonium fluoride; greater than or equal to 0.5 wt % and less than or equal to 10 wt % ammonium bifluoride; greater than or equal to 0.5 wt % and less than or equal to 10 wt % ammonium fluorosilicate; greater than or equal to 20 wt % and less than or equal to 40 wt % sulfuric acid; and greater than or equal to 40 wt % and less than or equal to 60 wt % water.

In embodiments, the etchant 210 may comprise greater than or equal to 10 wt % and less than or equal to 30 wt % ammonium fluoride; greater than or equal to 2 wt % and less than or equal to 15 wt % ammonium bifluoride; greater than or equal to 2 wt % and less than or equal to 20 wt % ammonium sulfate; greater than or equal to 0.5 wt % and less than or equal to 10 wt % ammonium fluorosilicate; greater than or equal to 0.5 wt % and less than or equal to 10 wt % ammonium chloride; greater than or equal to 2 wt % and less than or equal to 20 wt % hydrochloric acid; greater than or equal to 0.25 wt % and less than or equal to 5 wt % hexafluorosilicic acid; greater than or equal to 40 wt % and less than or equal to 60 wt % water; and greater than 0 wt % and less than or equal to 2 wt % xanthan gum.

The temperature of the etchant 210 may effect different etchants in different ways and may be altered to achieve sufficient coverage of the polyhedral surface features. For example, when the temperature of the etchant is relatively high (e.g., 24° C.), the activity of the F⁻ species and the solubility of (NH₄)₂SiF₆ in the etchant is high. Thus, the etchant may cause SiF₆ ions to be released more quickly from the surface of the glass article, which may result in polyhedral surface features with micro-uniformity, but lacking sufficient coverage. However, the etchant may include components (e.g., ammonium bifluoride) to counteract the relatively high etchant temperature by helping to form (NH₄)₂SiF₆, which may nucleate on the surface of the glass article

In embodiments, a temperature of the etchant 210 may be greater than or equal to 10° C. and less than or equal to 30° C. In embodiments, the temperature of the etchant is greater than or equal to 12° C. and less than or equal to 24° C. In embodiments, the temperature of the etchant 210 may be greater than or equal to 10° C., greater than or equal to 12° C., greater than or equal to 14° C., or even greater than or equal to 16° C. In embodiments, the temperature of the etchant 210 may be less than or equal to 30° C., less than or equal to 28° C., less than or equal to 26° C., or even less than or equal to 24° C. In embodiments, the temperature of the etchant 210 may be greater than or equal to 10° C. and less than or equal to 30° C., greater than or equal to 10° C. and less than or equal to 28° C., greater than or equal to 10° C. and less than or equal to 26° C., greater than or equal to 10° C. and less than or equal to 24° C., greater than or equal to 12° C. and less than or equal to 30° C., greater than or equal to 12° C. and less than or equal to 28° C., greater than or equal to 12° C. and less than or equal to 26° C., greater than or equal to 12° C. and less than or equal to 24° C., greater than or equal to 14° C. and less than or equal to 30° C., greater than or equal to 14° C. and less than or equal to 28° C., greater than or equal to 14° C. and less than or equal to 26° C., greater than or equal to 14° C. and less than or equal to 24° C., greater than or equal to 16° C. and less than or equal to 30° C., greater than or equal to 16° C. and less than or equal to 28° C., greater than or equal to 16° C. and less than or equal to 26° C., or even greater than or equal to 16° C. and less than or equal to 24° C., or any and all sub-ranges formed from any of these endpoints.

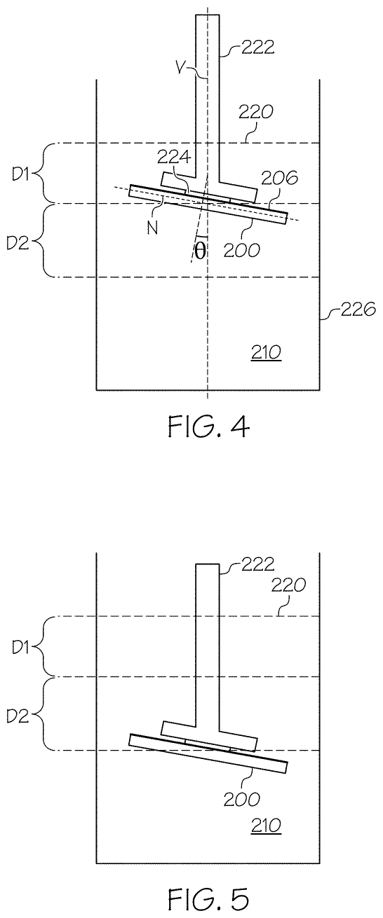

Referring back to FIG. 1 and to FIG. 4, the method continues at block 108 with submerging the aluminosilicate glass article 200 in an etchant 210 to an upper submerging depth D1 from a surface 220 of the etchant 210 and at a tilting angle θ. In embodiments, the aluminosilicate glass article 200 may be secured to an arm 222 to facilitate submerging the aluminosilicate glass article 200 in the etchant 210. For example, in embodiments, adhesive 224 may be disposed between the laminate 206 and the arm 222 to secure the aluminosilicate glass article 200 to the arm 222. The arm 222 may be lowered into a tank 226 containing etchant 210, thereby submerging the aluminosilicate glass article 200 in the etchant 210.

The tilting angle θ is a smallest angle between a normal N to the first major surface 202 and a vertical V. In embodiments, the tilting angle may be greater than or equal to 0° and less than or equal to 20° to help achieve sufficient coverage and a desired surface feature size on the textured glass article. In embodiments, the tilting angle may be greater than or equal to 0°, greater than or equal to 3°, greater than or equal to 5°, or even greater than or equal to 7°. In embodiments, the tilting angle may be less than or equal to 20°, less than or equal to 17°, less than or equal to 15°, or even less than or equal to 13°. In embodiments, the tilting angle may be greater than or equal to 0° and less than or equal to 20°, greater than or equal to 0° and less than or equal to 17°, greater than or equal to 0° and less than or equal to 15°, greater than or equal to 0° and less than or equal to 13°, greater than or equal to 3° and less than or equal to 20°, greater than or equal to 3° and less than or equal to 17°, greater than or equal to 3° and less than or equal to 15°, greater than or equal to 3° and less than or equal to 13°, greater than or equal to 5° and less than or equal to 20°, greater than or equal to 5° and less than or equal to 17°, greater than or equal to 5° and less than or equal to 15°, greater than or equal to 5° and less than or equal to 13°, greater than or equal to 7° and less than or equal to 20°, greater than or equal to 7° and less than or equal to 17°, greater than or equal to 7° and less than or equal to 15°, or even greater than or equal to 7° and less than or equal to 13°, or any and all sub-ranges formed from any of these endpoints.

Referring back to FIG. 1, the method 100 continues at block 110 with holding the aluminosilicate glass article 200 in the etchant 210 for a holding time. The aluminosilicate glass article 200 is held at the upper submerging depth D1 during the holding time. Holding time helps achieve sufficient coverage of the polyhedral surface features. In embodiments, the holding time may be greater than 0 s and less than or equal to 600 s. In embodiments, the holding time may be greater than or equal to 30 s and less than or equal to 300 s. In embodiments, the holding time may be greater than 0 s or even greater than or equal to 30 s. In embodiments, the holding time may be less than or equal to 600 s, less than or equal to 300 s, or even less than or equal to 120 s, or any and all sub-ranges formed from any of these endpoints. In embodiments, the holding time may be greater than 0 s and less than or equal to 600 s, greater than 0 s and less than or equal to 300 s, greater than 0 s and less than or equal to 120 s, greater than or equal to 30 s and less than or equal to 600 s, greater than or equal to 30 s and less than or equal to 300 s, or even greater than or equal to 30 s and less than or equal to 120 s, or any and all sub-ranges formed from any of these endpoints.

Referring back to FIG. 1 and to FIG. 5, the method continues at block 112 with, after the holding time, cycling the aluminosilicate glass article 200 in the etchant between the upper submerging depth D1 (as shown in FIG. 4) and a lower submerging depth D2 (as shown in FIG. 5) for a cycling time. In embodiments, the aluminosilicate glass article 200 is cycled by moving arm 222 in a repetitive upward and downward motion.

The lower submerging depth D2 is deeper than the upper submerging depth D1 relative to the surface 220 of the etchant 210. In embodiments, the lower submerging depth D2 may be greater than or equal to 1 cm and less than or equal to 20 cm deeper than the upper submerging depth D1. In embodiments, the lower submerging depth D2 may be greater than or equal to 3 cm and less than or equal to 8 cm deeper than the upper submerging depth D1. In embodiments, the lower submerging depth D2 may be greater than or equal to 1 cm, greater than or equal to 3 cm, or even greater than or equal to 5 cm deeper than the upper submerging depth D1. In embodiments, the lower submerging depth D2 may be less than or equal to 20 cm, less than or equal to 15 cm, or even less than or equal to 10 cm deeper than the upper submerging depth D1. In embodiments, the lower submerging depth D2 may be greater than or equal to 1 cm and less than or equal to 20 cm, greater than or equal to 1 cm and less than or equal to 15 cm, greater than or equal to 1 cm and less than or equal to 10 cm, greater than or equal to 3 cm and less than or equal to 20 cm, greater than or equal to 3 cm and less than or equal to 15 cm, greater than or equal to 3 cm and less than or equal to 10 cm, greater than or equal to 5 cm and less than or equal to 20 cm, greater than or equal to 5 cm and less than or equal to 15 cm, or even greater than or equal to 5 cm and less than or equal to 10 cm, or any and all sub-ranges formed from any of these endpoints, deeper than the upper submerging depth D1.

In embodiments, greater agitation parameters, such as cycles per minute and cycling speed, may lead to larger surface features size, which may be desirable to produce a reflective appearance. In embodiments, the cycling may be conducted at greater than or equal to 1 and less than or equal to 180 cycles per minute and at a speed of greater than or equal to 2 cm/s and less than or equal to 28 cm/s. In embodiments, the cycling may be conducted at greater than or equal to 2 and less than or equal to 120 cycles per minute and at a speed of greater than or equal to 4 cm/s and less than or equal to 24 cm/s.

In embodiments, the cycling may be conducted at greater than or equal to 1, greater than or equal to 2, greater than or equal to 10, greater than or equal to 30, or even greater than or equal to 60 cycles per minute. In embodiments, the cycling may be conducted at less than or equal to 180, less than or equal to 160, less than or equal to 140, or even less than or equal to 120 cycles per minute. In embodiments, the cycling may be conducted at greater than or equal to 1 and less than or equal to 180, greater than or equal to 1 and less than or equal to 160, greater than or equal to 1 and less than or equal to 140, greater than or equal to 1 and less than or equal to 120, greater than or equal to 2 and less than or equal to 180, greater than or equal to 2 and less than or equal to 160, greater than or equal to 2 and less than or equal to 140, greater than or equal to 2 and less than or equal to 120, greater than or equal to 10 and less than or equal to 180, greater than or equal to 10 and less than or equal to 160, greater than or equal to 10 and less than or equal to 140, greater than or equal to 10 and less than or equal to 120, greater than or equal to 30 and less than or equal to 180, greater than or equal to 30 and less than or equal to 160, greater than or equal to 30 and less than or equal to 140, greater than or equal to 30 and less than or equal to 120, greater than or equal to 60 and less than or equal to 180, greater than or equal to 60 and less than or equal to 160, greater than or equal to 60 and less than or equal to 140, or even greater than or equal to 60 and less than or equal to 120, or any and all sub-ranges of any of these endpoints, cycles per minute.

In embodiments, the cycling speed may be greater than or equal to 2 cm/s, greater than or equal to 4 cm/s, greater than or equal to 6 cm/s, greater than or equal to 8 cm/s or even greater than or equal to 10 cm/s. In embodiments, the cycling speed may be less than or equal to 28 cm/s, less than or equal to 24 cm/s, less than or equal to 20 cm/s, or even less than or equal to 16 cm/s. In embodiments

Cycling helps achieve sufficient coverage and micro-uniformity of the polyhedral surface features. In embodiments, the cycling time may be greater than or equal to 60 s and less than or equal to 900 s. In embodiments, the cycling time may be greater than or equal to 60 s, greater than or equal to 120 s, greater than or equal to 180 s, or even greater than or equal to 240 s. In embodiments, the cycling time may be less than or equal to 900 s, less than or equal to 780 s, less than or equal to 620 s, or even less than or equal to 500 s. In embodiments, the cycling time may be greater than or equal to 60 s and less than or equal to 900 s, greater than or equal to 60 s and less than or equal to 780 s, greater than or equal to 60 s and less than or equal to 620 s, greater than or equal to 60 s and less than or equal to 500 s, greater than or equal to 120 s and less than or equal to 900 s, greater than or equal to 120 s and less than or equal to 780 s, greater than or equal to 120 s and less than or equal to 620 s, greater than or equal to 120 s and less than or equal to 500 s, greater than or equal to 180 s and less than or equal to 900 s, greater than or equal to 180 s and less than or equal to 780 s, greater than or equal to 180 s and less than or equal to 620 s, greater than or equal to 180 s and less than or equal to 500 s, greater than or equal to 240 s and less than or equal to 900 s, greater than or equal to 240 s and less than or equal to 780 s, greater than or equal to 240 s and less than or equal to 620 s, or even greater than or equal to 240 s and less than or equal to 500 s, or any and all sub-ranges formed from any of these endpoints.

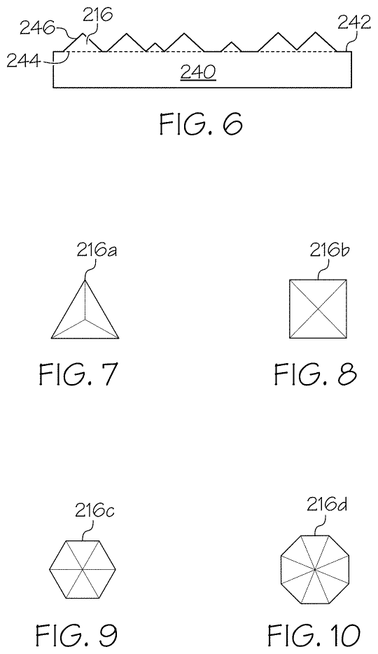

Referring back to FIG. 1 and to FIG. 6, the method 100 continues at block 114 with removing the aluminosilicate glass article 200 from the etchant 210, washing the aluminosilicate glass article 200 to remove the etchant 210 and crystal seeds 214 from the surface, and drying the article to form the textured glass article 240 having polyhedral surface features 216. The aluminosilicate glass article 200 may be removed from arm 222. In embodiments, the etchant may be rinsed off the aluminosilicate glass article 200 with deionized (DI) water. In embodiments, crystal seeds 214 adhering to the aluminosilicate glass article 200 may be removed or scratched off by, for example, a scrubber sponge. In embodiments, the laminate 206 may be removed. In embodiments, the aluminosilicate glass article 200 may be dried in ambient condition or in an oven.

As shown in FIG. 6, the resulting textured glass article 240 comprises a plurality of polyhedral surface features 216 extending from a first surface 242. Each of the plurality of polyhedral surface features 216 comprises a base 244 on the first surface 242 and a plurality of facets 246 extending from the first surface 242.

In embodiments, the facets 246 of each polyhedral surface feature 216 extend from the first surface 242 and converge toward one another to form the polyhedral morphology (e.g., pyramidal with 3-fold symmetry, 4-fold symmetry, 6-fold symmetry, etc.) of the polyhedral surface features 216. For example, as shown in FIGS. 7-10, in embodiments, the polyhedral surface features 216 may comprise triangular pyramids 216a, quadrangular pyramids 216b, hexagonal pyramids 216c, octagonal pyramids 216d, or a combination thereof. In embodiments, the textured glass article 240 may comprise a dominate texture phase and a minor texture phase. For example, in embodiments, the textured glass article 240 may comprise hexagonal and octagonal pyramids as the dominate texture phase. In embodiments, the textured glass article 240 may comprise hexagonal and octagonal pyramids as the dominate texture phase with triangular pyramids as the minor texture phase. In embodiments, the textured glass article 240 may comprise quadrangular pyramids as the dominate texture phase.

In embodiments, a surface feature size at the base 244 may be greater than or equal to 50 μm and less than or equal to 500 μm. In embodiments, the surface feature size at the base 244 may be greater than or equal to 50 μm, greater than or equal to 75 μm, or even greater than or equal to 100 μm. In embodiments, the surface feature size at the base 244 may be less than or equal to 500 μm, less than or equal to 400 μm, or even less than or equal to 300 μm. In embodiments, the surface feature size at the base 244 may be greater than or equal to 50 μm and less than or equal to 500 μm, greater than or equal to 50 μm and less than or equal to 400 μm, greater than or equal to 50 μm and less than or equal to 300 μm, greater than or equal to 75 μm and less than or equal to 500 μm, greater than or equal to 75 μm and less than or equal to 400 μm, greater than or equal to 75 μm and less than or equal to 300 μm, greater than or equal to 100 μm and less than or equal to 500 μm, greater than or equal to 100 μm and less than or equal to 400 μm, or even greater than or equal to 100 μm and less than or equal to 300 μm, or any and all sub-ranges formed from any of these endpoints.

The structure and size of each polyhedral surface feature 216, along with sufficient coverage a micro-uniformity thereof, helps to achieve enhanced glowing.

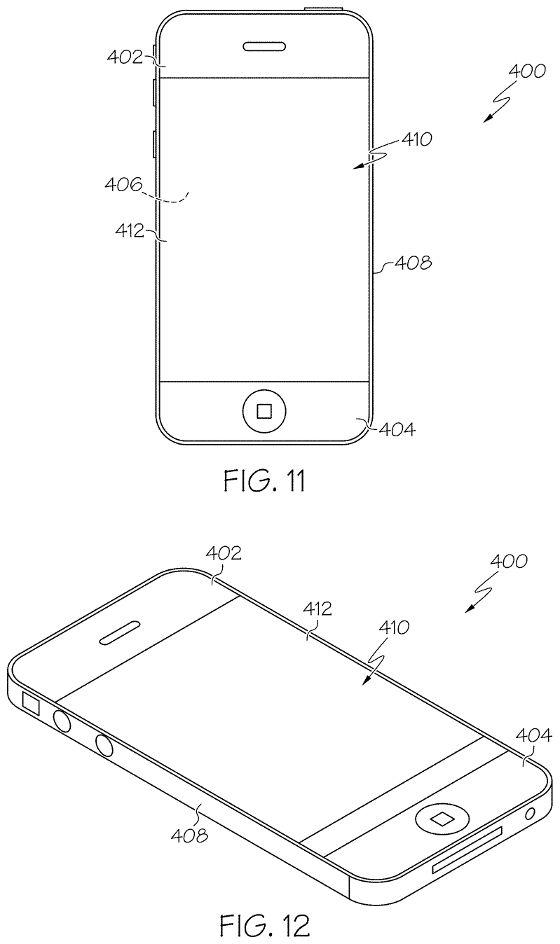

The textured glass articles described herein may be used for a variety of applications including, for example, back cover applications in consumer or commercial electronic devices such as smartphones, tablet computers, personal computers, ultrabooks, televisions, and cameras. An exemplary article incorporating any of the textured glass articles disclosed herein is shown in FIGS. 11-13. Specifically, FIGS. 11-13 show a consumer electronic device 400 including a housing 402 having front 404, back 406, and side surfaces 408; electrical components (not shown) that are at least partially inside or entirely within the housing and including at least a controller, a memory, and a display 410 at or adjacent to the front surface of the housing; and a cover substrate 412 at or over the front surface of the housing such that it is over the display. In embodiments, a portion of housing 402, such as the back 406, may include any of the textured glass articles disclosed herein.

### EXAMPLES

In order that various embodiments be more readily understood, reference is made to the following examples, which illustrate various embodiments of the textured glass articles described herein.

The compositions of Glass Articles A and B (in mol %) treated as described below are shown in Table 1. Note that reference to “Glass Article A” and “Glass Article B” refers to a glass article that has the respective composition shown in Table 1. References to Glass Articles A and B do not refer to the same Glass Articles A and B, respectively, that were treated multiple times with the various etchants.

TABLE 1

| Glass Article | A | B |
|---|---|---|
| SiO₂ | 64.40 | 58.65 |
| Al₂O₃ | 15.90 | 17.85 |
| B₂O₃ | — | 4.22 |
| Na₂O | 11.00 | 8.72 |
| K₂O | — | 0.07 |
| Li₂O | 6.30 | 7.70 |
| MgO | — | 1.19 |
| ZnO | 1.20 | — |
| P₂O₅ | 1.25 | 1.47 |
| TiO₂ | — | 0.10 |

Table 2 shows the composition of Example Etchants A-F and Comparative Etchant A (in wt %). The xanthan gum included in Example Etchant F was KELZAN (CP Kelvo).

TABLE 2

| | Example | Example | Example | Example |
|---|---|---|---|---|
| Etchant | Etchant A | Etchant B | Etchant C | Etchant D |
| NH₄F | 10.0 | 12.0 | 17.8 | — |
| NH₄HF₂ | 7.2 | 2.6 | — | 17.0 |
| (NH₄)₂SO₄ | 7.2 | 10.8 | — | 11.8 |
| (NH₄)₂SiF₆ | 2.2 | 3.3 | 2.1 | — |
| NH₄Cl | 3.2 | — | — | — |
| H₂SO₄ | — | — | 32.0 | 23.6 |
| HCl | 11.7 | 14.3 | — | — |
| H₂SiF₆ | 1.1 | — | — | — |
| H₂O | 57.7 | 57.1 | 48.1 | 47.5 |
| xanthan gum | — | — | — | — |

| | Example | Comparative | Example |
|---|---|---|---|
| Etchant | Etchant E | Etchant A | Etchant F |
| NH₄F | 17.4 | 16.9 | 9.9 |
| NH₄HF₂ | 3.5 | 3.4 | 6.9 |
| (NH₄)₂SO₄ | — | — | 7.2 |
| (NH₄)₂SiF₆ | 0.7 | 0.7 | 2.2 |
| NH₄Cl | — | — | 3.2 |
| H₂SO₄ | 31.3 | 36.8 | — |
| HCl | — | — | 11.7 |
| H₂SiF₆ | — | — | 1.1 |
| H₂O | 47.1 | 42.2 | 57.7 |
| xanthan gum | — | — | 0.1 |

### Example 1—Example Textured Article A (Etchant A and Glass Article A)

To obtain Etchant A, 543 g blended powder including 33.8 wt % NH₄F, 23.5 wt % NH₄HF₂, 24.3 wt % (NH₄)₂SO₄, 7.4 wt % (NH)₂SiF₆, and 11.0 wt % NH₄Cl was obtained by hand mill. 1195 ml pre-mixed solvent including 41.4 vol % 37 wt % HCl, 4.2 vol % H₂SiF₆, and 51.4 vol % H₂O was obtained and stirred adequately. The mixture of powder and solvent was performed at 24° C. The etchant was aged for 2 hours.

Glass Article A was cut to 50×50 mm size and laminated on one side. The laminated Glass Article A underwent a 10 min ultrasonic treatment in 3% Parker aqueous solution, followed by adequate rinsing with running DI water. Thereafter, Glass Article A was dried at 60° C. oven, followed by placement in ambient condition until Glass Article A cooled to 24° C.

Before etching, Etchant A had a settling time of 300 s. The tilting angle θ, upper submerging depth D1, lower submerging depth D2, and holding time were 0°, 0.5 cm, 6 cm, and 30 s, respectively. The cycling time was 4 min with 2 cycles per minute. The cycling speed was 4 cm/s. The temperature of the etchant was 24° C.

Etched Glass Article A was flushed with running DI water. The precipitates on the etched glass article were removed by scratching and the lamination film was peeled off. The glass article was placed in a 60° C. oven until dry.

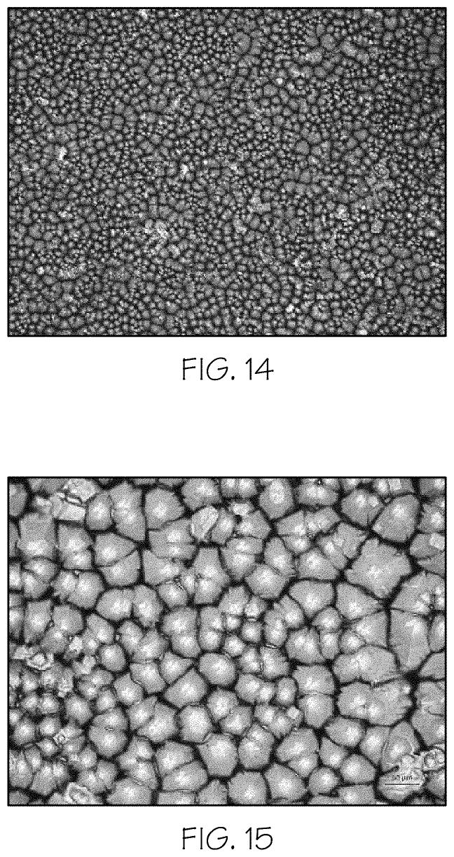

Referring now to FIGS. 14 and 15, treating Glass Article A with Etchant A using the agitation parameters described hereinabove resulted in Example Textured Article A having sufficient coverage and micro-uniformity of the resulting polyhedral surface features. FIG. 15 shows that the Example Textured Article A included hexagonal and octagonal pyramids as the dominate texture phase. The surface feature size at the base of the polyhedral surface features was 70 μm.

### Example 2—Example Textured Article B (Etchant B and Glass Article A)

To obtain Etchant B, 350 g blended powder including 41.8 wt % NH₄F, 9.1 wt % NH₄HF₂, 37.7 wt % (NH₄)₂SO₄, and 11.4 wt % (NH)₂SiF₆ was obtained by hand mill. 800 ml pre-mixed solvent including 50.0 vol % 37 wt % HCl, and 50.0 vol % H₂O was obtained and stirred adequately. The mixture of powder and solvent was performed at 24° C. The etchant was aged for 2 hours.

Glass Article A was subjected to the same treatment as in Example 1 prior to etching.

Before etching, Etchant B had a settling time of 300 s. The tilting angle θ, upper submerging depth, lower submerging depth D2, and holding time were 10°, 0.5 cm, 6 cm, and 30 s, respectively. The cycling time was 4 min with 60 cycles per minute. The cycling speed of each agitation cycle was 12 cm/s. The temperature of the etchant was 24° C.

Etched Glass Article A was subjected to the same treatment as in Example 1 after etching.

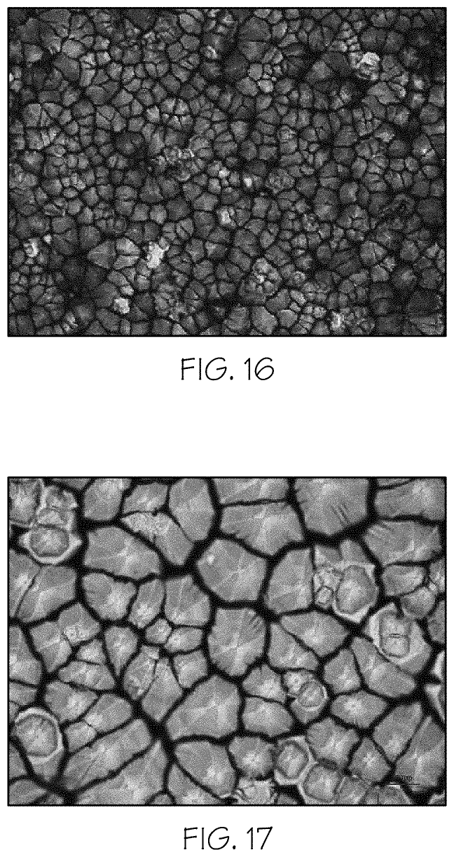

Referring now to FIGS. 16 and 17, treating Glass Article A with Etchant B using the agitation parameters described hereinabove resulted in Example Textured Article B having sufficient coverage and micro-uniformity of the resulting polyhedral surface features. FIG. 17 shows that Example Textured Article B included hexagonal and octagonal pyramids as the dominate texture phase with triangular pyramids as the minor texture phase. The surface feature size at the base of the polyhedral surface features was 90 μm.

### Example 3—Example Textured Article B (Etchant B and Glass Article A)

Example 2 was modified to include 120 cycles per minute and a cycling speed of 24 cm/s, while maintaining all other agitation parameters.

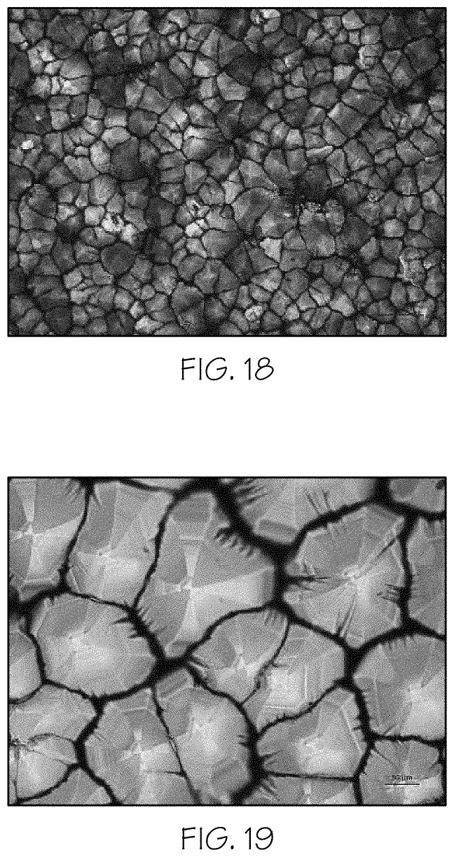

Referring now to FIGS. 18 and 19, treating Glass Article A with Etchant B using the agitation parameters described hereinabove results in Example Textured Article C having sufficient coverage and micro-uniformity of the resulting polyhedral surface features. FIG. 19 shows that Example Textures Article C included hexagonal and octagonal pyramids as the dominate texture phase with triangular pyramids as the minor texture phase.

The surface feature size at the base of the polyhedral surface features of Example Textured Article C was 170 μm, whereas the surface feature size at the base of the polyhedral surface features of Example Textured Article B was 90 μm. As indicated by Examples 2 and 3, greater agitation parameters (e.g., greater cycles per minute and greater cycling speed) results in a larger surface feature size of the polyhedral surface features.

### Comparative Example 1—Comparative Textured Article A

Example 3 was repeated without cycling (i.e., cycling time=0 s, holding time=240 s), while maintaining all other agitation parameter parameters.

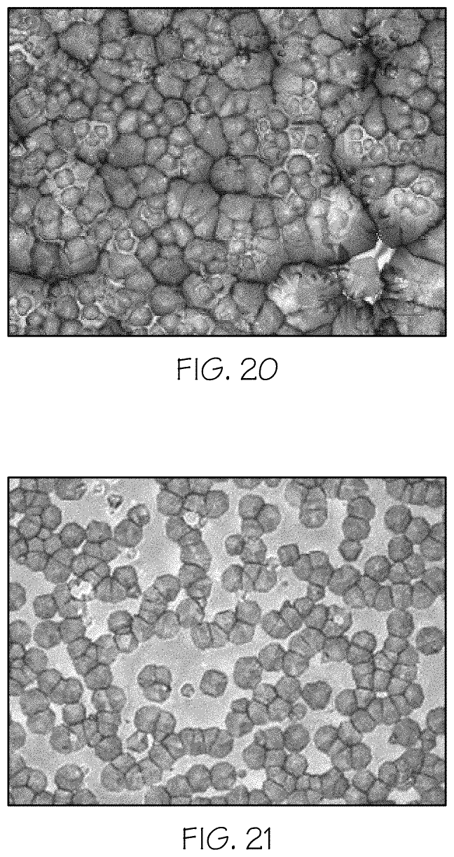

Referring now to FIG. 20, treating Glass Article A with Etchant B without cycling described hereinabove resulted in polyhedral surface features, but lacked sufficient coverage and micro-uniformity. As indicated by Example 3 and Comparative Example 1, cycling helps achieve sufficient coverage and micro-uniformity of the polyhedral surface features on the textured glass article.

### Comparative Example 2—Comparative Textures Article B

Example 3 was repeated without holding (i.e., holding time=0 s), while maintaining all other agitation parameters.

Referring now to FIG. 21, treating Glass Article A with Etchant B without holding as described hereinabove resulted in polyhedral surface features having micro-uniformity, but lacking sufficient coverage. As indicated by Example 3 and Comparative Example 2, holding time helps achieve sufficient coverage of the polyhedral surface features on textured glass article.

### Example 4— Example Textured Article D (Etchant C and Glass Article A)

To obtain Etchant C, 112 g blended powder including 89.3 wt % NH₄F and 10.7 wt % (NH)₂SiF₆ was obtained by hand mill. 367 ml pre-mixed solvent including 27.2 vol % 98 wt % H₂SO₄ and 72.8 vol % H₂O was obtained and stirred adequately. The mixture of powder and solvent was performed at 24° C. The etchant was aged for 2 hours.

Glass Article A was subjected to the same treatment as in Example 1 prior to etching.

Before etching, Etchant C had a settling time of 300 s. The tilting angle θ, upper submerging depth D1, lower submerging depth D2, and holding time were 0°, 0.5 cm, 6 cm, and 30 s, respectively. The cycling time was 10 min with 2 cycles per minute. The cycling speed was 4 cm/s. The temperature of the etchant was 12° C.

Etched Glass Article A was subjected to the same treatment as in Example 1 after etching.

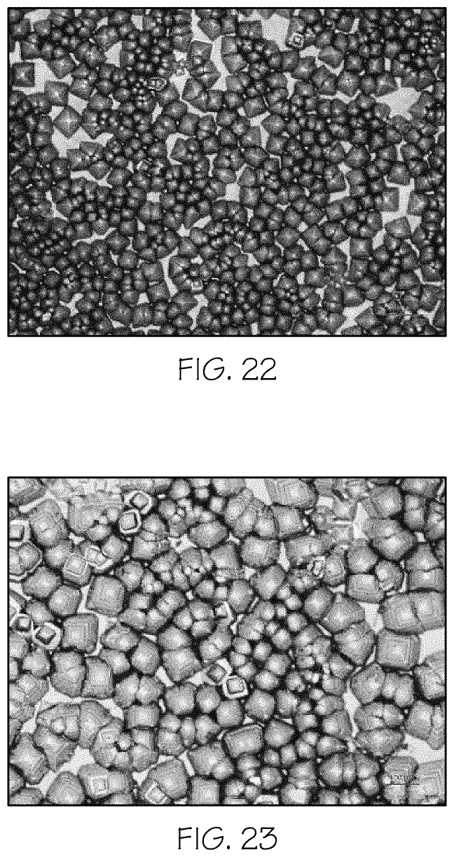

Referring now to FIGS. 22 and 23, treating Glass Article A with Etchant C using the agitation parameters described hereinabove resulted Example Textured Glass Article D having sufficient coverage and micro-uniformity of the resulting polyhedral surface features. FIG. 23 shows that Example Textured Article D included quadrangular pyramids as the dominate texture phase. The surface feature size at the base of the polyhedral surface features was 100 μm.

### Comparative Example 3—Comparative Textured Article C

Example 4 was repeated with the temperature of the etchant being 24° C., while maintaining all other agitation parameters.

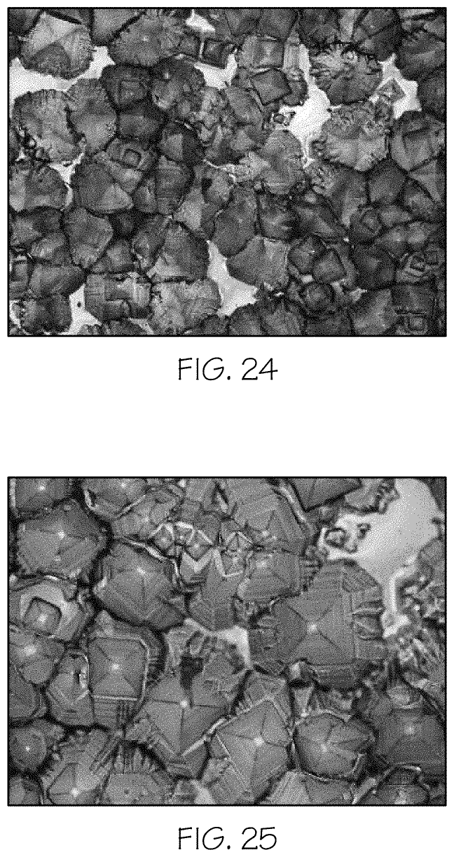

Referring now to FIGS. 24 and 25, treating Glass Article A with Etchant C with a relatively increased etching temperature as described hereinabove resulted in Comparative Textured Article C having polyhedral surface features with micro-uniformity, but lacking sufficient coverage. The surface feature size at the base of the polyhedral surface features was 300 μm.

Example 4 and Comparative Example 3 utilized Example Etchant C, which did not include ammonium bifluoride. The relatively high etchant temperature of 24° C. caused SiF₆ ions to be released more quickly from the surface of the glass article, which resulted in polyhedral surface features with micro-uniformity, but lacking sufficient coverage.

Note that the temperature of the etchant in Examples 1-3 was 24° C. and resulted in textured glass articles having sufficient coverage a micro-uniformity. Examples 1-3 utilized Example Etchants A and B, respectively, which included ammonium bifluoride. Ammonium bifluoride present in the etchant counteracts the relatively high etchant temperature by helping to form (NH₄)₂SiF₆, which may nucleate on the surface of the glass article.

As indicated by Examples 1˜4 and Comparative Example 3, the temperature of the etchant effects different etchants in different ways and may be altered to achieve sufficient coverage of the polyhedral surface features on the textured glass article.

### Example 5— Example Textured Article E (Etchant D and Glass Article A)

To obtain Etchant D, 176 g blended powder including 59.1 wt % NH₄HF₂ and 40.9 wt % (NH₄)₂SiO₄ was obtained by hand mill. 367 ml pre-mixed solvent including 21.8 vol % 98 wt % H₂SO₄ and 78.2 vol % H₂O was obtained and stirred adequately. The mixture of powder and solvent was performed at 24° C. The etchant was aged for 2 hours.

Glass Article A was subjected to the same treatment as in Example 1 prior to etching.

Before etching, Etchant D had a settling time of 300 s. The tilting angle θ, upper submerging depth D1, lower submerging D2, and holding time were 0°, 0.5 cm, 6 cm, and 30 s, respectively. The cycling time was 4 min with 2 cycles per minute. The cycling speed was 4 cm/s. The temperature of the etchant was 24° C.

Etched Glass Article A was subjected to the same treatment as in Example 1 after etching.

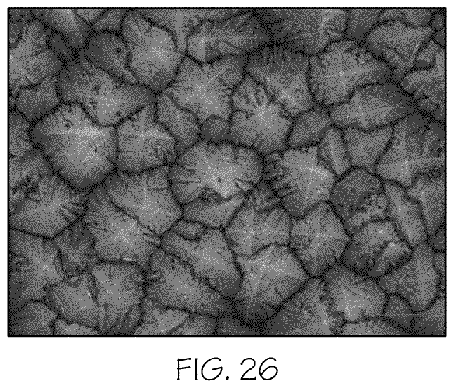

Referring now to FIG. 26, treating Glass Article A with Etchant D using the agitation parameters described hereinabove resulted in Example Textured Article E having sufficient coverage and micro-uniformity of the resulting polyhedral surface features. FIG. 26 shows that Example Textured Article B included quadrangular pyramids as the dominate texture phase. The surface feature size at the base of the polyhedral surface features was 350 μm

### Example 6— Example Textured Article F (Etchant E and Glass Article B)

To obtain Etchant E, 124 g blended powder including 80.6 NH₄F, 16.1 wt % NH₄HF₂ and 3.3 wt % (NH₄)₂SiF₆ was obtained by hand mill. 367 ml pre-mixed solvent including 27.2 vol % 98 wt % H₂SO₄ and 72.8 vol % H₂O was obtained and stirred adequately. The mixture of powder and solvent was performed at 24° C. The etchant was aged for 2 hours.

Glass Article B was subjected to the same treatment as Glass Article A in Example 1 prior to etching.

Before etching, Etchant E had a settling time of 300 s. The tilting angle θ, upper submerging depth D1, lower submerging depth D2, and holding time were 0°, 0.5 cm, 6 cm, and 30 s, respectively. The cycling time was 10 min with 2 cycles per minute. The cycling speed was 4 cm/s. The temperature of the etchant was 12° C.

Etched Glass Article B was subjected to the same treatment as Etched Glass Article A in Example 1 after etching.

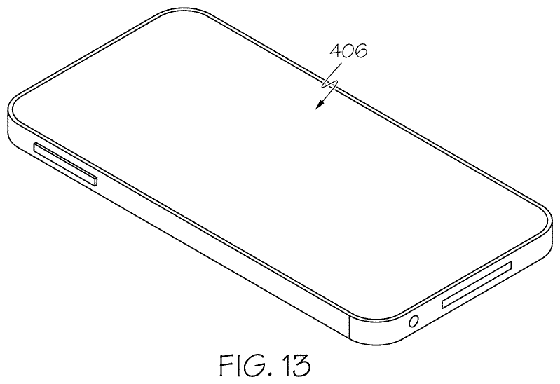

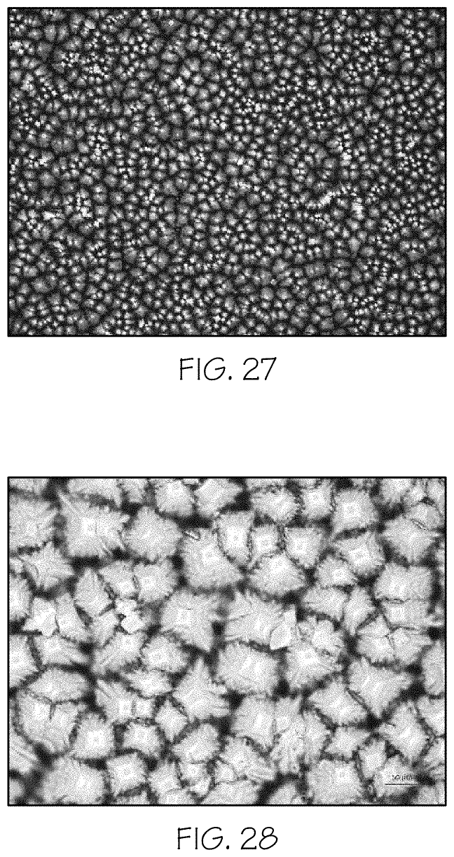

Referring now to FIGS. 27 and 28, treating Glass Article B with Etchant E using the agitation parameters described hereinabove resulted in Example Textured Article F having sufficient coverage and micro-uniformity of the resulting polyhedral surface features. FIG. 13 shows that Example Textured Article B included quadrangular pyramids as the dominate texture phase. The surface feature size at the base of the polyhedral surface features was 70 μm.

### Comparative Example 4—Comparative Textured Article D

Example 6 was repeated with a reverse tilting angle of 10° (i.e., the major surface contacting the etchant was facing the top surface of the etchant at a tilting angle of 10°), while maintaining all other agitation parameters.

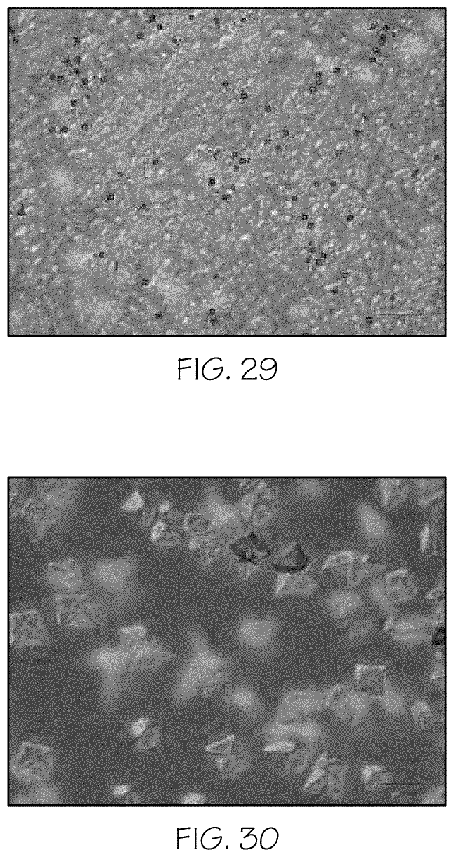

Referring now to FIG. 29, treating Glass Article B with Etchant E with a reverse titling angle as described hereinabove resulted in Comparative Textured Article D lacking sufficient coverage and having a relatively small surface feature size of the polyhedral surface features. As indicated by Example 6 and Comparative Example 4, a tilting angle of greater than or equal to 0 and less than or equal to 20° helps achieve sufficient coverage and a larger surface feature size of the polyhedral surface features on the texture glass article.

### Comparative Example 5—Comparative Textured Article E

Example 6 was repeated using Comparative Etchant A, while maintaining the agitation parameters

Referring now to FIG. 30, treating Glass Article B with Comparative Etchant A using the agitation parameters described hereinabove resulted in Comparative Textured Article E lacking sufficient coverage and having relatively small surface feature size of the polyhedral surface features. As indicated by Example 6 and Comparative Example 5, increasing acid concentration may result in reduced coverage and relatively small surface feature size.

### Example 7—Example Textured Article G (Etchant F and Glass Article A)

Example 1 was repeated using Etchant F with a settling time of 30 s, 60 cycles per minute, and a cycling speed of 12 cm/s, while maintaining all other agitation parameters.

To obtain Etchant F, 544.5 g blended powder including 33.7 wt % NH₄F, 23.4 wt % NH₄HF₂, 24.2 wt % (NH₄)₂SO₄, 7.3 wt % (NH)₂SiF₆, 11.0 wt % NH₄Cl, and 0.28 wt % xanthan gum was obtained by hand mill. 1195 ml pre-mixed solvent including 41.4 vol % 37 wt % HCl, 4.2 vol % H₂SiF₆, and 51.4 vol % H₂O was obtained and stirred adequately. The mixture of powder and solvent was performed at 40° C. The etchant was aged for 2 hours. The viscosity of Etchant F was 130 mPas at 24° C. as measured by a Brookfield DT2 viscometer with LV-01 spindle and rotation speed of 30 rpm.

Treating Glass Article A with Etchant F as described hereinabove resulted in Example Textured Article G having sufficient coverage and micro-uniformity of the resulting polyhedral surface features. The Example Textured Article G included hexagonal and octagonal pyramids as the dominate texture phase. The surface feature size at the base of the polyhedral surface features was 70 μm.

### Comparative Example 6—Comparative Textured Article F

Example 1 was repeated with a settling time of 30 s, 60 cycles per minute, and a cycling speed of 12 cm/s, while maintain all other processing factors. The viscosity of Example Etchant A was 10 mPas at 24° C. as measured by a Brookfield DT2 viscometer with LV-01 spindle and rotation speed of 30 rpm.

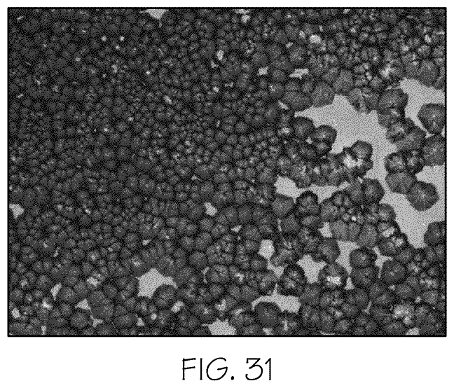

Referring now to FIG. 31, treating Glass Article A with Example Etchant A using the settling time, cycles per minute, and cycling speed described hereinabove resulted in Comparative Textured Article F having micro-uniformity, but lacking sufficient coverage. As indicated by Example 7 and Comparative Example 6, the presence of xanthan gum in the etchant may be important to increase the viscosity of the etchant, thereby achieving sufficient coverage when the settling time is relatively short.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A method of forming a textured glass article, the method comprising:
submerging an aluminosilicate glass article in an etchant to an upper submerging depth from a surface of the etchant and at a tilting angle, wherein the aluminosilicate glass article comprises a first major surface and a second major surface opposite the first surface, wherein the tilting angle is a smallest angle between a normal to the first major surface and a vertical;
holding the aluminosilicate glass article in the etchant for a holding time; and
after the holding time, cycling the aluminosilicate glass article in the etchant between the upper submerging depth and a lower submerging depth deeper than the upper submerging depth for a cycling time.

2. The method of claim 1, wherein the tilting angle is greater than or equal to 0° and less than or equal to 20°.

3. The method of claim 1, wherein the holding time is greater than 0 s and less than or equal to 600 s.

4. The method of claim 1, wherein a temperature of the etchant is greater than or equal to 10° C. and less than or equal to 30° C.

5. The method of claim 1, wherein the cycling is conducted at greater than or equal to 1 and less than or equal to 180 cycles per minute and at a speed of greater than or equal to 2 cm/s and less than or equal to 28 cm/s.

6. The method of claim 1, wherein the lower submerging depth is greater than or equal to 1 cm and less than or equal to 20 cm deeper than the upper submerging depth.

7. The method of claim 1, further comprising, prior to submersing the aluminosilicate glass article in the etchant, preparing the etchant and allowing the etchant to settle for a settling time greater than or equal to 10 s and less than or equal to 600 s.

8. The method of claim 1, wherein the cycling time is greater than or equal to 60 s and less than or equal to 900 s.

9. The method of claim 1, wherein the etchant comprises:
greater than or equal to 10 wt % and less than or equal to 50 wt % of a salt, the salt comprising ammonium fluoride, ammonium bifluoride, ammonium sulfate, ammonium fluorosilicate, ammonium chloride, or combinations thereof; and
greater than or equal to 5 wt % and less than or equal to 50 wt % of an acid, the acid comprising hydrochloric acid, sulfuric acid, hexafluorosilicic acid, or combinations thereof.

10. The method of claim 1, wherein the etchant comprises greater than 0 wt % and less than or equal to 2 wt % xanthan gum.

11. The method of claim 1, herein the aluminosilicate glass article comprises greater than or equal to 14 wt % Al₂O₃.

12. The method of claim 1, wherein the textured glass article comprises a plurality of polyhedral surface features extending from a first surface, each of the plurality of polyhedral surface features comprising a base on the first surface, a plurality of facets extending from the first surface, and a surface feature size at the base greater than or equal to 50 μm and less than or equal to 500 μm, wherein the plurality of facets of each polyhedral surface feature converge toward one another.

13. An etchant comprising:
greater than or equal to 10 wt % and less than or equal to 50 wt % of a salt, the salt comprising ammonium fluoride, ammonium bifluoride, ammonium sulfate, ammonium fluorosilicate, ammonium chloride, or combinations thereof; and
greater than or equal to 5 wt % and less than or equal to 50 wt % of an acid, the acid comprising hydrochloric acid, sulfuric acid, hexafluorosilicic acid, or combinations thereof.

14. The etchant of claim 13, wherein the etchant comprises greater than 0 wt % and less than or equal to 2 wt % xanthan gum.

15. The etchant of claim 13, wherein the etchant comprises:
greater than or equal to 2 wt % and less than or equal to 20 wt % ammonium fluoride;
greater than or equal to 2 wt % and less than or equal to 15 wt % ammonium bifluoride;
greater than or equal to 2 wt % and less than or equal to 15 wt % ammonium sulfate;
greater than or equal to 0.5 wt % and less than or equal to 10 wt % ammonium fluorosilicate;
greater than or equal to 0.5 wt % and less than or equal to 10 wt % ammonium chloride;
greater than or equal to 2 wt % and less than or equal to 20 wt % hydrochloric acid;
greater than or equal to 0.25 wt % and less than or equal to 5 wt % hexafluorosilicic acid; and
greater than or equal to 50 wt % and less than or equal to 70 wt % water.

16. The etchant of claim 13, wherein the etchant comprises:
greater than or equal to 2 wt % and less than or equal to 20 wt % ammonium fluoride;
greater than or equal to 0.5 wt % and less than or equal to 10 wt % ammonium bifluoride;
greater than or equal to 2 wt % and less than or equal to 25 wt % ammonium sulfate;
greater than or equal to 0.5 wt % and less than or equal to 10 wt % ammonium fluorosilicate;
greater than or equal to 5 wt % and less than or equal to 25 wt % hydrochloric acid; and
greater than or equal to 50 wt % and less than or equal to 70 wt % water.

17. The etchant of claim 13, wherein the etchant comprises:
greater than or equal to 5 wt % and less than or equal to 30 wt % ammonium fluoride;
greater than or equal to 0.5 wt % and less than or equal to 10 wt % ammonium fluorosilicate;
greater than or equal to 20 wt % and less than or equal to 40 wt % sulfuric acid; and
greater than or equal to 40 wt % and less than or equal to 60 wt % water.

18. The etchant of claim 13, wherein the etchant comprises:
greater than or equal to 5 wt % and less than or equal to 30 wt % ammonium bifluoride;
greater than or equal to 2 wt % and less than or equal to 20 wt % ammonium sulfate;
greater than or equal to 15 wt % and less than or equal to 35 wt % sulfuric acid; and
greater than or equal to 40 wt % and less than or equal to 60 wt % water.

19. The etchant of claim 13, wherein the etchant comprises:
greater than or equal to 10 wt % and less than or equal to 30 wt % ammonium fluoride;
greater than or equal to 0.5 wt % and less than or equal to 10 wt % ammonium bifluoride;
greater than or equal to 0.5 wt % and less than or equal to 10 wt % ammonium fluorosilicate;
greater than or equal to 20 wt % and less than or equal to 40 wt % sulfuric acid; and
greater than or equal to 40 wt % and less than or equal to 60 wt % water.

20. The etchant of claim 13, wherein the etchant comprises:
greater than or equal to 10 wt % and less than or equal to 30 wt % ammonium fluoride;
greater than or equal to 2 wt % and less than or equal to 15 wt % ammonium bifluoride;
greater than or equal to 2 wt % and less than or equal to 20 wt % ammonium sulfate;
greater than or equal to 0.5 wt % and less than or equal to 10 wt % ammonium fluorosilicate;
greater than or equal to 0.5 wt % and less than or equal to 10 wt % ammonium chloride;
greater than or equal to 2 wt % and less than or equal to 20 wt % hydrochloric acid;
greater than or equal to 0.25 wt % and less than or equal to 5 wt % hexafluorosilicic acid;
greater than or equal to 40 wt % and less than or equal to 60 wt % water; and
greater than 0 wt % and less than or equal to 2 wt % xanthan gum.
